(19) United States
(12) Patent Application Publication
(10) Pub. No.: US 2014/0259819 A1
(43) Pub. Date: Sep. 18, 2014

(54) INTERNALLY ILLUMINATED CUSTOM LICENSE PLATE

(71) Applicant: Jason B. Dalpra, Melbourne, FL (US)

(72) Inventor: Jason B. Dalpra, Melbourne, FL (US)

(21) Appl. No.: 14/205,102

(22) Filed: Mar. 11, 2014

Related U.S. Application Data
(60) Provisional application No. 61/782,295, filed on Mar. 14, 2013.

(51) Int. Cl. G09F 13/00; B60Q 1/56

(52) U.S. Cl. CPC G09F 13/00; B60Q 1/56
USPC 40/204

(57) ABSTRACT

A self-contained, internally illuminated custom license plate that enables trouble free usage in automotive applications due to the internal location of the light source. The integration of the light source allows the plate to be visible both day and night. An exemplary embodiment of the illuminated custom license plate includes a transparent plate with desired text, graphic or logo etched therein, a light source, a front cover, and a power cable.

### FIELD

The embodiments described herein generally relate to custom license plates and more particularly, to an internally illuminated custom license plate.

### BACKGROUND INFORMATION

The custom license plate market is composed of a wide variety of plates ranging from mass-produced stamped aluminum plates to plastic plates personalized with airbrushing or vinyl and even edge lit plates. There are also similar products in the signage industry such as edge lit signs. Examples of current industry products, such as, e.g., a stamped aluminum plate, a laser cut acrylic plate, an edge lit plate and an edge lit sign are shown in FIGS. 1A, 1B, 1C and 1D.

### SUMMARY

The embodiments described herein are directed to an internally illuminated custom license plate. The internally illuminated custom license plate described herein provides a self-contained design that enables trouble free usage in adverse conditions due to the internal location of the light source. Also, by being illuminated, the plate and any particular signage on the plate can be seen at any time of the day or night. The aesthetic benefits of this design allow the plate to be made with no outer frame (structural or decorative) and/or banding. This plate has a distinct look due to the fact that the design integrates the light source within the geometry of the license plate.

An exemplary embodiment of e illuminated custom license plate includes 5 major components: a transparent plate with the desired text, graphic or logo etched therein, a light source, front and rear covers coupled to the plate and a power cable such as a 2-conductor insulated copper wire. The front and rear covers are preferably coupled to the plate using double-sided adhesive film. The plate preferable includes two-place mounting, an access hole for the power cable, and a unique pocket for integrally mounting the light source hardware.

In an alternative embodiment, the illuminated custom license plate includes a plate having a plate profile along its upper edge, a back cover having a recess with a shape that is a mirror image of the plate profile, a light source mountable internally to and interposing the plate and back cover, and a conductor coupled to the light source and couplable to a power source.

Other systems, methods, features and advantages of the example embodiments will be or will become apparent to one with skill in the art upon examination of the following figures and detailed description.

### BRIEF DESCRIPTION OF THE FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIGS. 1A, 18, 1C and 1D comprise photographs of examples of license plates and signs in the art.

FIGS. 2A, 28 and 2C comprise photographs of example embodiments of a internally illuminated custom license plate.

FIGS. 3A and 3B are assembled and exploded perspective views of one embodiment of the internally illuminated custom license plate.

FIG. 4 is a plan view of a plate of the internally illuminated custom license plate.

FIG. 5A is a profile view of a light source of the internally illuminated custom license plate.

FIG. 5B is a photograph of the light source.

FIG. 6 is a plan view of front and back covers of the internally illuminated custom license plate.

FIG. 7A is a profile view of a power cable of the internally illuminated custom license plate.

FIG. 7B is a photograph of the power cable.

FIG. 8 is an exploded perspective view of another embodiment of the internally illuminated custom license plate.

It should be noted that elements of similar structures or functions are generally represented by like reference numerals for illustrative purpose throughout the figures. It should also be noted that the figures are only intended to facilitate the description of the preferred embodiments.

### DESCRIPTION

Each of the additional features and teachings disclosed below can be utilized separately or in conjunction with other features and teachings to produce internally illuminated custom license plate. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detailed description may not be necessary o practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

The embodiments provided herein are directed to internally illuminated custom license plate. The internally illuminated custom license plate described herein provides a self-contained design that enables trouble free usage in adverse conditions due to the internal location of the light source. Also, by being illuminated, the plate and any particular signage on the plate can be seen at any time of the day or night, see FIGS. 2A, 2B and 2C. The aesthetic benefits of this design allow the plate to be made with no outer frame (structural or decorative) and/or banding. This plate has a distinct look due to the fact that the design integrates the light source within the geometry of the license plate.

Turning to the figures, an exemplary embodiment of the illuminated custom license plate 10 is shown in FIGS. 3A and 3B to include 4 to 5 major components: a plate 20 with the desired text, graphic or logo etched therein, a light source 16, front and rear covers 12 and 14, and a power cable 15. The power cable 15 is preferable a 2-conductor insulated copper wire. The front and rear covers 12 and 14 are preferably coupled or adhered to the plate 20 using, an adhesive or as shown in FIG. 3B, double side adhesive film 18.

The plate 20 serves as both the main structural component for securing the other components and the medium in which to display signage. The plate 20, which is preferably transparent or translucent, is rectangular in shape and is made out of cast acrylic sheet, sized to the standard automotive license plate. The plate is approximately 3/16 inch thick, 6 inches tall and 12 inches wide. As shown in FIG. 4, the plate 20 has features incorporated therein such as through holes 22 that enable two-place mounting, an access hole 24 for the power cable 15, and a unique pocket or channel 26 for internal mounting of the light source hardware 16. The signage 28 may be displayed as text, a graphic or a logo, and may be applied in a variety of methods, including: engraving, machine or laser, and print, silk or UV cure.

Turning to FIGS. 5A and 5B, the tight source 16 could be a variety of hardware that fits the geometry of the rectangular pocket or channel 26 in the plate 20. It could be a flexible or rigid LED strip (SMD or through-hole) or Electroluminescent (EL) wire. For a example prototype device, a flexible 2.6 mm wide SMD LED strip was used.

As shown in FIG. 6, the front and rear covers 12 and 14 serve to protect the light source 16 and provide secondary structural support. The are rectangular in shape as ell and in the example prototypes were made out of 0.032 inch thick aluminum sheet.

The power cable 15, shown in FIG. 7 as a two-conductor copper wire, is used to transfer power from a power source (switched 12VDC in this case) to the light source (LEDs) 16 through the access holes and 24 in the rear cover 14 and plate 20.

Incorporating the light source 16 into the plate 20 allows hermetic sealing of the light source 16 and a clean, distinct appearance. Since the light source 16, as shown in FIGS. 3 and 8, is internal and not located along the outer edge, there's no protective frame or channel extrusion required. This is an improvement over the signage industries solution which is typically a standardized aluminum channel (see FIG. 1), not aesthetically appealing or particularly well suited for the automotive use.

In an alternative embodiment shown in FIG. 8, the device 110 includes five major components: a plate 120, a front cover 112, a back cover 114, a light source 116 and a power cable 115. As depicted, the front and back covers 112 and 114 includes through holes 118 and 138 that enable two position mounting. The plate 120, which is preferably transparent or translucent, preferably includes a upper profile 122 that includes two tabs 124 positioned at opposing ends of a top edge 128 and vertically extending above the top edge 128, The back cover 114 preferably includes a recess profile 130 matching the shape of the plate profile 112. As depicted, the back cover profile 130 has an elongate recess 132 longitudinally extending along the bottom of the back cover 114 and two tab recesses 134 positioned at opposing ends of a top edge 131 of the longitudinally extending elongate recess 132 and vertically extending above the top edge 131. When assembled, the back cover 114 is positioned on the plate 120 such that the plate profile 122 is received in the recesses 132 and 134 of the cover profile 130. The tabs 124 are sized to be taller than the tab recesses 134 are deep resulting in an elongate gap or channel between the top edge 128 of the plate profile 122 and the top edge 131 of the elongate recess 132 and in which the light source 116 is positioned. A power access hole 135 is provided in the back cover 114 to provide access for the power cable 115 to the light source 116. The tabs 124 and tab recesses 134 include mounting holes 126 and 136 sized to receive mounting pins (not shown) extending from the front cover 112.

The example embodiments provided herein, however, are merely intended as illustrative examples and not to be limiting in any way.

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed:

1. An license plate comprising:
a plate,
a light source mountable internally to the plate, and
a conductor coupled to the light source and couplable to a power source.

2. The license plate of claim 1 wherein the plate includes a channel or slot formed therein to internally mount the light source.

3. The license plate of claim 1 wherein the light source is one of a flexible or rigid LED strip (SMD or through-hole) and an Electroluminescent (EL) wire.

4. The license plate of claim 1 further comprising a front cover mountable to the plate over the light source.

5. The license plate of claim 4 wherein the front cover is HDPE.

6. The license plate of claim 4 further comprising a back cover couplable to the plate.

7. The license plate of claim 1 wherein the conductor is a 2-conductor insulated copper wire.

8. The license plate of claim 1 wherein the plate is transparent.

9. The license plate of claim 1 wherein the plate is an acrylic sheet.

10. The license plate of claim 6 wherein the front and back covers are coupled to the plate with double-sided adhesive film.

11. An license plate comprising:
a plate having a plate profile along its upper edge,
a back cover having a recess with a shape that is a mirror image of the plate profile,
a light source mountable internally to and interposing the plate and back cover, and
a conductor coupled to the light source and couplable to a power source.

12. The license plate of claim 11 wherein the plate and the back cover form a channel or slot there between to internally mount the light source.

13. The license plate of claim 11 wherein the light source is one of a flexible or rigid LED strip (SMD or through-hole) and an Electroluminescent (EL) wire.

14. The license plate of claim 11 further comprising a front cover mountable to the plate over the light source.

15. The license plate of claim 14 wherein the front cover is HDPE.

16. The license plate of claim 11 wherein the conductor is a 2-conductor insulated copper wire.

17. The license plate of claim 11 wherein the plate is transparent.

18. The license plate of claim 11 wherein the plate is an acrylic sheet.

19. The license plate of claim 16 wherein the plate profile includes a longitudinally extending top edge and first and second tabs positioned adjacent opposing ends of the top edge and extending vertically beyond the top edge, and wherein the back cover recess includes a longitudinally extending recess and first and second tab recesses extending vertically above a top edge of the longitudinally extending recess.

20. The license plate of claim 19 wherein the front and back covers are coupled to the plate with first and second pins extending from the front cover and configured to engage first and second pin holes in the first and second tabs of the plate and first and second pin holes in the first and second tab recesses of the back cover.
